(19) United States
(12) Patent Application Publication
(10) Pub. No.: US 2025/0372273 A1
(43) Pub. Date: Dec. 4, 2025

(54) RADIOACTIVE GAS CONTAINMENT SYSTEM FOR NUCLEAR WASTE CONTAINERS

(71) Applicant: INGECID, S.L., SANTANDER (CANTABRIA) (ES)

(72) Inventors: Jokin RICO ARENAL, SANTANDER (CANTABRIA) (ES); Diego RODRÍGUEZ SÁEZ, SANTANDER (CANTABRIA) (ES)

(21) Appl. No.: 18/878,046

(22) PCT Filed: Jul. 5, 2023
(86) PCT No.: PCT/ES2023/070432

§ 371 Date: Dec. 22, 2024

(30) Foreign Application Priority Data
Jul. 8, 2022 (ES) P202230631

(51) Int. Cl. G21F 5/12

(52) U.S. Cl. CPC G21F 5/12

(57) ABSTRACT

A radioactive gas containment system for nuclear waste containers comprising: a first flange (1) for fixing the system to a nuclear waste container (C); bolts (11) for horizontally tightening the first fixing flange (1) against the container (C); a cap (2) for covering an upper portion of the container (C); a containment gasket (3) arranged between the cap (2) and the first fixing flange (1); bolts (4) for vertically tightening the cap (2) against the first fixing flange (1) and the containment gasket (3) arranged between the cap (2) and said first fixing flange (1); and a device (5) for pressurising the space between the container (C) and the cap (2) and controlling the radioactive gases.

### TECHNICAL FIELD

The present invention is applicable to nuclear waste containers and specifically relates to a system for the containment of possible radioactive gases originating from the waste housed in said containers.

### BACKGROUND ART

Currently, nuclear waste storage systems are known that comprise containers intended for the storage of said waste and that have closure lids that are fixed to the container, for example, by means of bolts that tighten gaskets that prevent the exit to the outside of the radioactive gases emitted by the nuclear waste, said lids and gaskets forming a containment system for the radioactive gases inside the container.

In the event that any of these gaskets were to fail, a leak of radioactive gas into the atmosphere would occur, with the risk that this entails.

Therefore, the technical problem that arises is the development of a radioactive gas containment system, applicable to the aforementioned nuclear waste containers, which prevents the release of radioactive gases to the outside in the event that a gas leak occurs, for any reason, in the containment system of the container itself.

The applicant for the invention is unaware of the existence on the market of a gas containment system for nuclear waste containers with the characteristics of the present invention.

### SUMMARY OF THE INVENTION

The radioactive gas containment system object of the present invention has technical characteristics that allow to satisfactorily solve the problem set forth above, and solve the leakage of radioactive gases in nuclear waste containers, not only during storage operations but also during transportation operations.

To this end, and according to the invention, this radioactive gas containment system comprises: a first flange for fixing the system to the container; bolts for horizontally tightening this first fixing flange against the container; a cap for covering the upper portion of the container where the lids are fixed; a containment gasket arranged between the cap and the first fixing flange; bolts for vertically tightening the cap against the first fixing flange and the containment gasket arranged between the cap and said first fixing flange; and a device for pressurising the space between the container and the cap and controlling the radioactive gases.

The characteristics of this system allow it to be assembled quickly and easily on the container. simply by: placing and fixing the first flange around the container, by means of the horizontally tightening bolts, in an area near its upper end; placing the containment gasket on said first flange and then covering the upper portion of the container located above said first flange with a cap, and fixing said cap to the first anchoring flange by means of the vertically tightening bolts.

These vertically tightening bolts, in addition to fixing the cap to the first flange, establish the tightening of the containment gasket arranged between them, which is responsible for preventing the release of radioactive gases through the area of attachment of the cap to said first flange.

Said first flange is arranged around the container and comprises bolts for horizontally tightening said first flange against the container, said first flange forming the means for fixing the system to the container.

This first flange comprises vertical holes for mounting the vertically tightening bolts of the cap against said first flange.

Advantageously, the cap comprises a top wall and a side wall defining an open lower cavity, the cap covering the upper portion of the container; a second flange being fixed to said side wall, facing the first fixing flange and provided with vertical mounting holes for the vertically tightening bolts.

The device for pressurising the space between the container and the cap, and controlling against gas leakage, is mounted on the cap. This pressurising device preferably comprises a one-way valve that allows the introduction of a pressurised fluid into said space, minimising the risk of radioactive gas release to the outside of the container.

### BRIEF DESCRIPTION OF THE CONTENTS OF THE DRAWINGS

In order to complement the description that is being carried out and with the purpose of facilitating the understanding of the characteristics of the invention, the present description is accompanied by a set of drawings wherein, by way of an illustrative and non-limiting example, the following has been depicted:

FIG. 1 shows a perspective view of an exemplary embodiment of the radioactive gas containment system for nuclear waste containers, according to the invention, exploded and facing the upper end of a nuclear waste container.

FIG. 2 shows a view analogous to the previous one, with the system of the invention mounted in the position of use on the upper end of the nuclear waste container.

FIG. 3 shows a magnified detail, in elevation, of a lateral end of the system of the invention sectioned by a vertical plane and mounted on an upper portion of a nuclear waste container.

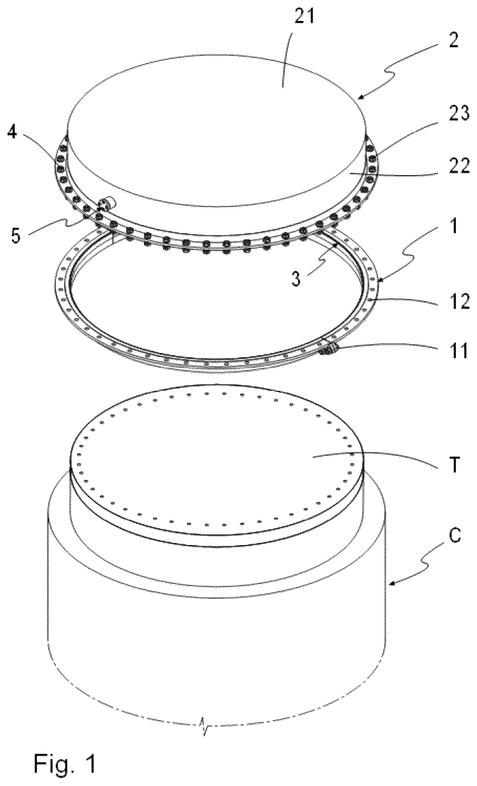

### DETAILED EXPLANATION OF EMBODIMENTS OF THE INVENTION

As can be seen in the attached figures, this system is applicable to nuclear waste containers (C) that have their own sealing means, consisting of a closure lid (T) and the corresponding sealing gasket (not shown).

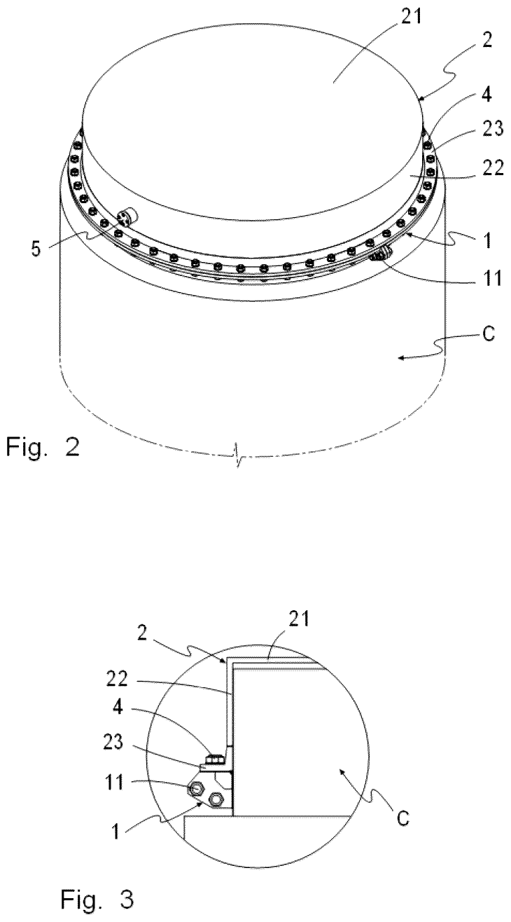

In the embodiment shown in the figures, the system of the invention comprises a first fixing flange (1) provided with horizontally tightening bolts (11) for fixing around the container (C), and vertical holes (12) for mounting vertically tightening bolts (4) of a cap (2) covering an upper portion of the container (C), as shown in FIGS. 2 and 3.

This cap (2) comprises a top wall (21) and a side wall (22), which delimit an open lower cavity for receiving the upper portion of the container (C).

The cap (2) has at the lower end of its side wall (22) a second flange (23) provided with vertical holes, facing the vertical holes (12) of the first flange (1), and in which the vertically tightening bolts (4) are mounted.

Between the first flange (1) and the second flange (23) a containment gasket (3) is mounted, which is pressed by said flanges and establishes a perimeter closure that prevents the release of radioactive gases to the outside.

The cap (2) comprises a device (5) for pressurising the space between said cap (2) and the container (C), thus minimising the risk of radioactive gases being released to the outside of the container (C).

Having sufficiently described the nature of the invention and an exemplary preferred embodiment, it is stated for all pertinent purposes that the materials, shape, size and arrangement of the described elements are susceptible to changes, provided that this does not involve an alteration of the essential features of the invention which are claimed below.

1. A radioactive gas containment system for nuclear waste containers, comprising:
a first flange (1) for fixing the system to a nuclear waste container (C);
bolts (11) for horizontally tightening said first flange (1) against the container (C),
a cap (2) covering an upper portion of the container (C),
a containment gasket (3) arranged between the cap (2) and the first fixing flange (1),
bolts (4) for vertically tightening the cap (2) against the first fixing flange (1) and the containment gasket (3) arranged between the cap (2) and said first fixing flange (1), and
a device (5) for pressurising the space between the container (C) and the cap (2), and controlling the radioactive gases.

2. The system according to claim 1, wherein the first flange (1) comprises vertical holes (12) for mounting the bolts (4) for vertically tightening the cap (2) against said first flange (1).

3. The system according to claim 1, wherein the cap (2) comprises a top wall (21) and a side wall (22) defining an open lower cavity covering the upper portion of the container (C).

4. The system according to claim 3, wherein the cap (2) comprises a second flange (23) fixed to its side wall (22), facing the first fixing flange (1) and provided with vertical mounting holes for the vertically tightening bolts (4).

5. The system according to claim 1, wherein the device (5) for pressurising the space between the container (C) and the cap (2) is mounted on the cap (2).

6. The system according to claim 1, which is used during the storage or transport conditions of the container (C).
